(19) United States
(12) Patent Application Publication
(10) Pub. No.: US 2015/0373293 A1
(43) Pub. Date: Dec. 24, 2015

(54) VIDEO ACQUISITION WITH ADAPTIVE FRAME RATE

(71) Applicant: Sony Corporation, Tokyo (JP)

(72) Inventors: Scott Vance, Staffanstorp (SE); Åke Rydgren, Sodra Sandby (SE); Mattias Wideheim, Malmo (SE)

(21) Appl. No.: 14/312,820

(22) Filed: Jun. 24, 2014

(51) Int. Cl. H04N 5/44; H04N 19/132; G06K 9/00; H04N 19/172; H04N 19/587; H04N 5/232; H04N 19/463; H04N 19/139

(52) U.S. Cl. CPC H04N 5/4401; H04N 19/463; H04N 19/132; H04N 19/139; H04N 19/172; H04N 19/587; H04N 5/23258; G06K 9/00597

(57) ABSTRACT

A device is provided which comprises a camera configured to acquire a video at a first frame rate. The device further comprises an interface configured to receive control information which indicates a current environmental condition. The camera is further configured to acquire the video at a second frame rate in response to a change of the current environmental condition.

### FIELD OF THE INVENTION

Embodiments relate to a device comprising a camera configured to adaptively acquire a video at two or more frame rates, a corresponding system, and a corresponding method.

### BACKGROUND OF THE INVENTION

Video acquisition offers the possibility of capturing action and movement in moving pictures. However, typically the storing of a video requires significant memory space. The memory space typically scales with a frame rate at which the video is acquired. While higher frame rates typically offer increased quality of the video, at the same time the memory demands increase. Also, high frame rates often cause increased energy consumption of the camera and associated entities and may cause reduced operation cycles between battery recharging in particular for mobile devices; further, significant heating of the camera and associated entities may result from high frame rates.

### BRIEF SUMMARY OF THE INVENTION

Therefore, a need exists to avoid or reduce negative impacts as mentioned above when acquiring the video at high frame rates.

According to an embodiment, a device is provided. The device comprises a camera configured to acquire a video at a first frame rate. The device further comprises an interface configured to receive control information. The control information indicates a current environmental condition of an environment of the device. The camera is further configured to acquire the video at a second frame rate in response to a change of the current environmental condition.

According to a further embodiment, a system is provided. The system comprises at least one sensor configured to measure a current environmental condition of an environment of the sensor. The at least one sensor is further configured to send control information indicating the current environmental condition. The system further comprises a camera configured to acquire a video at a first frame rate. The system further comprises an interface in communication with the at least one sensor. The interface is configured to receive the control information. The camera is configured to acquire the video at a second frame rate in response to a change of the current environmental condition.

According to an embodiment, a method is provided. The method comprises acquiring a video at a first frame rate. The method further comprises, while acquiring the video: receiving control information. The control information indicates a current environmental condition of an environment of the device. The method further comprises selectively acquiring the video at a second frame rate in response to a change of the current environmental condition.

Although specific features described in the above summary and in the following detailed description are described in connection with specific embodiments and aspects, it is to be understood that the features of the embodiments and aspects may be combined with each other unless specifically noted otherwise.

### BRIEF DESCRIPTION OF THE DRAWINGS

Embodiments of the invention will now be described in more detail with reference to the accompanying drawings.

FIG. 1 shows a system comprising a device and three sensors.

FIG. 2 illustrates control information indicating a current environmental condition of an environment of the device.

FIG. 3 schematically illustrates adapting a frame rate of video acquisition in response to a change of the current environmental condition.

FIG. 4 shows a time evolution of the environmental condition and further shows a time evolution of the frame rate.

FIG. 5 is a flow chart of a method according to various embodiments.

### DESCRIPTION OF EMBODIMENTS

In the following, exemplary embodiments of the invention will be described in greater detail. It is to be understood that the following description is given only for the purpose of illustrating the principles of the invention and is not to be taken in a limiting sense. Rather, the scope of the invention is defined by the appended claims and is not intended to be limited by the exemplary embodiments hereinafter.

Hereinafter, techniques of adapting a frame rate of video acquisition with a camera are explained. In particular, a change of the frame rate occurs in response to a change of environmental conditions of an environment of the respective device including the camera. For this purpose, it is possible to receive control information via an interface of the device, the control information indicating the current environmental condition. It is further possible to measure the current environmental condition with one or more sensors which can be coupled wirelessly or by fixed-wire communication with the interface. The sensor may monitor the environment of the device.

In other words, in dependence of the current environmental condition, it is possible to flexibly adapt the frame rate of the video acquisition. In this manner, it is, e.g., possible to acquire the video at a comparably high (low) frame rate if there are fast (slow) dynamics occurring in the environment of the device. E.g., if the device is moving quickly, it may be desirable to acquire the video at a comparably high frame rate. On the other hand, if, e.g., the surrounding of the device is comparably static or not changing quickly, it may be desirable to acquire the video at a comparably low frame rate, thereby still sufficiently covering the ongoing dynamics.

By such techniques, it may be ensured that a high frame rate is selectively and purposively employed when it is actually necessary to cover fast dynamics. In such a manner, often unwanted side effects of the video acquisition at comparably high frame rates can be avoided or limited to a necessary degree. Such side effects may include, but are not limited to: increased storage requirements; increased energy consumption; and/or increased system heating.

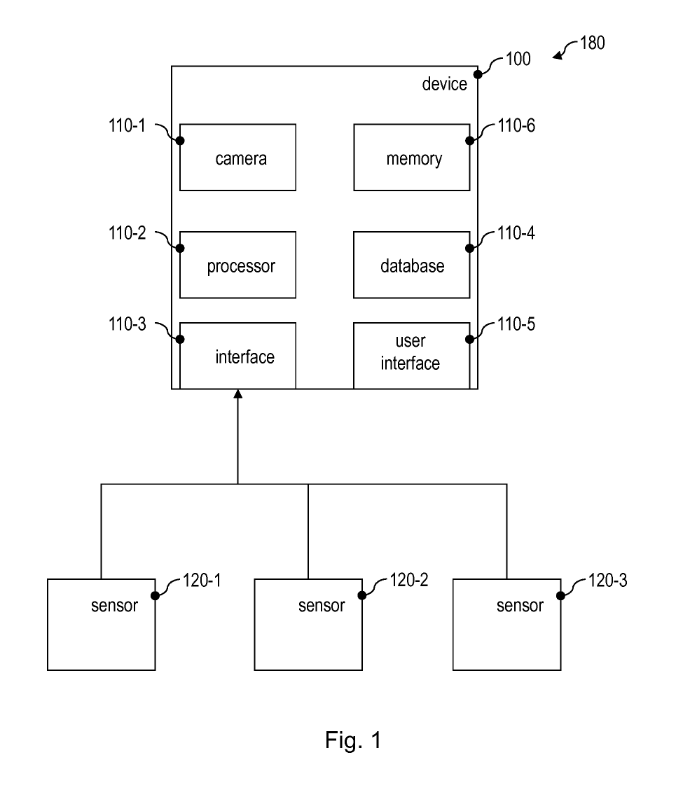

Turning to FIG. 1, a system 180 is shown. The system 180 includes a device 100. The device 100 includes a camera 110-1, a processor 110-2, and an interface 110-3. Further, the device 100 includes a database 110-4 and a user interface 110-5. The camera 110-1 is configured to acquire a video. Acquiring the video may correspond to: capturing and/or storing image data in a memory 110-6 corresponding to frames.

The interface 110-3 is in communication with three sensors 120-1, 120-2, 120-3. A larger or smaller number of sensors 120-1, 120-2, 120-3 may be provided. In particular, the interface 110-3 is configured to receive control information from each one of the sensors 120-1, 120-2, 120-3, e.g., repeatedly in fixed time intervals or in response to certain predefined trigger events. It is possible that the interface 110-3, prior to receiving the control information, sends a request message to the respective one of the sensors 120-1, 120-2, 120-3 thereby triggering the sending of the control information.

The control information indicates one or more current environmental conditions of an environment of the device 100. Each one of the sensors 120-1, 120-2, 120-3 measures a respective type of environmental condition and sends the measured environmental condition as part of the control information to the interface 110-3. E.g., the interface 110-3 can be coupled wirelessly or with a fixed-line communication to the sensors 120-1, 120-2, 120-3. The wireless communication can be according to the Bluetooth standard and/or according to the Wifi standard and/or according to the Near Field Communication standard. It is possible that there are more or less sensors 120-1, 120-2, 120-3 provided in the system 180. Each sensor 120-1, 120-2, 120-3 may provide the control information for one or more types of environmental conditions.

In general, it is possible that some or all of the sensors 120-1, 120-2, 120-3 are colocated with the device 100. However, it is also possible that some or all of the sensors 120-1, 120-2, 120-3 are included with entities different than the device 100. E.g., the device 100 can be a mobile device such as a mobile phone, laptop, smartphone, tablet PC, or the like. Likewise, it would be possible that the sensors 120-1, 120-2, 120-3 are included in a wrist watch, smart watch, glasses, and/or wearable electronics such as shoes, jackets, or the like.

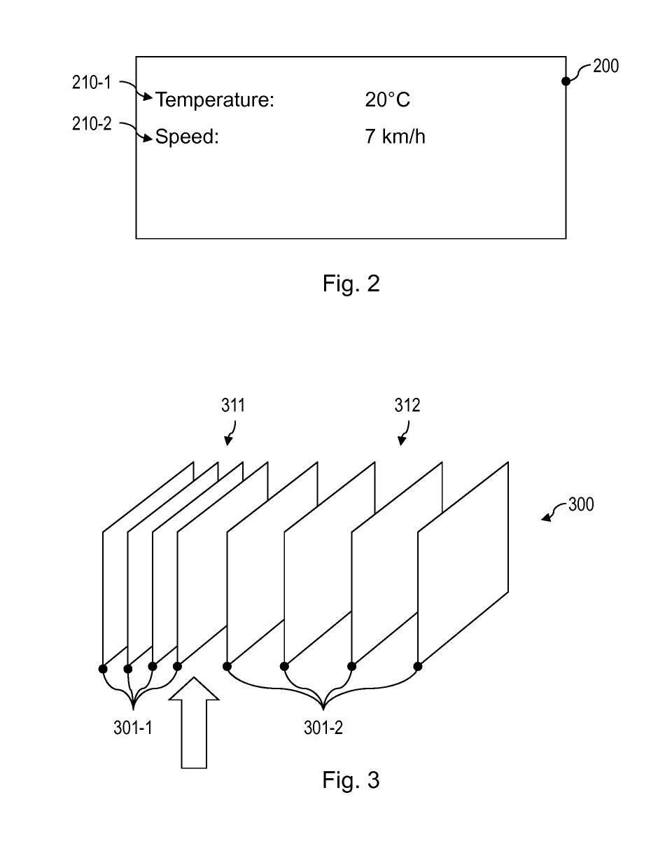

Turning to FIG. 2, control information 200 including environmental conditions 210-1, 210-2 is illustrated. In the scenario of FIG. 2, the control information 200 includes environmental conditions 210-1, 210-2 relating to an ambient temperature and to a speed of the device 100, i.e., a change of the position per time interval. In general, a larger number or smaller number of environmental conditions 210-1, 210-2 could be included in the control information 200. In general, various types of environmental conditions 210-1, 210-2 can be included in the control information 200.

In FIG. 3, the video 300 is schematically illustrated. In particular, the video 300 corresponds to a time series of frames 301-1, 301-2. Each frame 301-1, 301-2 includes image data captured at a given point in time with the camera 110-1 and stored in the memory 110-6. A first part of the frames 301-1 is acquired at a first frame rate 311. A second part of the frames 301-2 is acquired at a second frame rate 312. The first frame rate 311 is higher than the second frame rate 312; i.e., a time interval between subsequent frames 301-1, 301-2 is larger (smaller) for the second frame rate 312 (first frame rate 311). E.g., the first frame rate 311 can be between 30 and 200 frames per second, preferably between 50 and 150 frames per second. E.g., the second frame rate 312 can be between 5 and 30 frames per second, preferably between 20 and 27 frames per second, more preferably amount to 24 frames per second. Other values of the first and second frame rates 311, 312 are possible. Adapting the frame rate 311, 312 may correspond to: adapting the time delay between subsequently captured frames 301-1, 301-2 and/or adapting the time delay between subsequently stored frames 301-1, 301-2.

As can be seen from FIG. 3, when adapting the frame rate 311, 312, there is no temporal gap present in the video 300. In other words: the acquisition of the video 300 is not interrupted by the adaptation of the frame rate 311, 312. The change from video acquisition at the first frame rate 311 to video acquisition at the second frame rate 312 is triggered by a change in the environmental conditions 210-1, 210-2 (as indicated in FIG. 3 by the vertical arrow). In the scenario of FIG. 3, the change from the first frame rate 311 to the second frame rate 312 occurs abruptly; intermediate frame rates are not employed and the change is implemented as a step-function. However, it is possible to implement the change from the first frame rate 311 to the second frame rate 312 in a gradual manner, i.e., employing some transition period where the video acquisition occurs with intermediate frame rates between the first and second frame rates 311, 312. This may allow achieving a smoother transition between the first and second frame rates 311, 312. A transition time period may be employed amounting to, e.g., 2-5 seconds. The transition time period may be determined in dependence of the change of the current environmental condition; e.g., larger (smaller) changes of the environmental condition may result in larger (smaller) transition time periods.

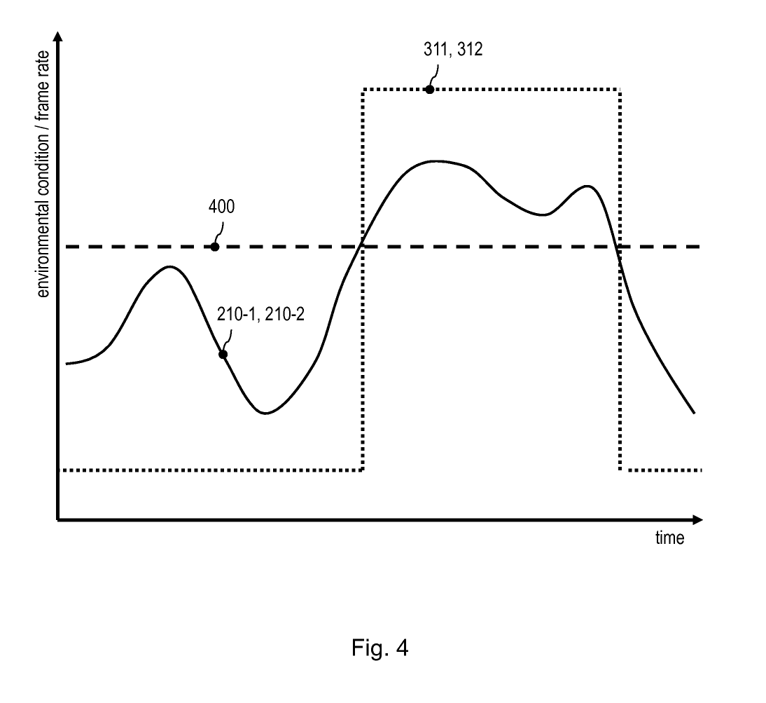

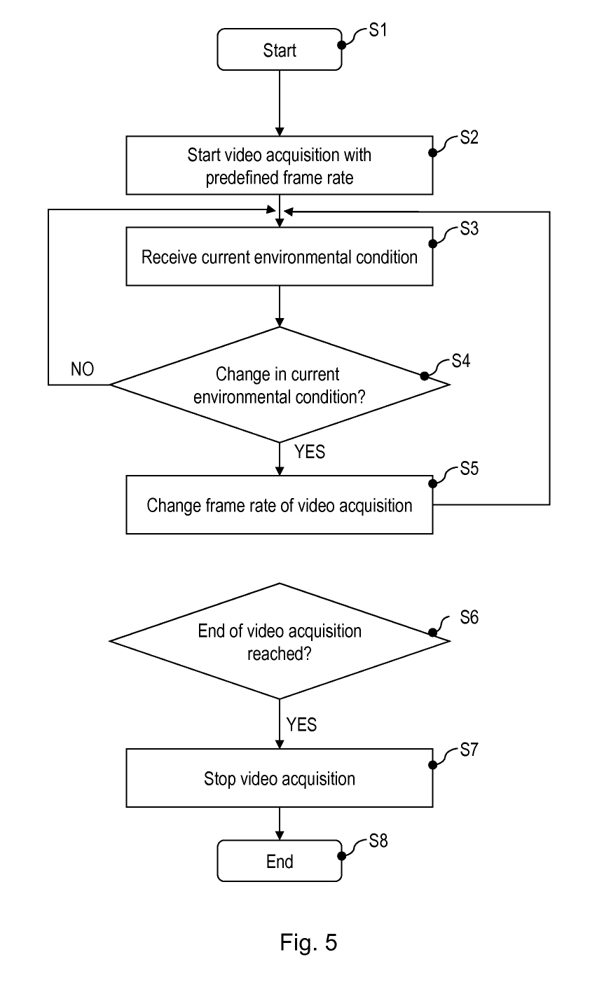

A change of the environmental condition 210-1, 210-2 is illustrated in FIG. 4. In FIG. 4, the horizontal axis indicates the time; the vertical axis indicates the environmental condition 210-1, 210-2 (full line) and the frame rate 311, 312 (dotted line). E.g., the processor 110-2 can be configured to execute a threshold comparison of the environmental condition 210-1, 210-2 with a predefined threshold 400. The processor 110-2 can be configured to command the camera 110-1 to acquire the video at the second frame rate 312 in dependence of the threshold comparison. E.g., if an absolute value of the environmental condition 210-1, 210-2 falls below the predefined threshold 400, the video can be acquired at the second frame rate 312. While in FIG. 4 the decision criterion for adaptation of the frame rate 311, 312 is shown with respect to a given single environmental condition 210-1, 210-2 only, it is possible that respective threshold comparisons are executed by the processor 110-2 for different types of environmental conditions 210-1, 210-2. When executing such a threshold comparison, it is further possible to take into account certain latency. I.e., before adapting the frame rate 311, 312, it may be required to fulfill the decision criterion for a certain predefined or user-defined duration.

As can be seen from the above, it is possible to adapt the frame rate 311, 312 of the video acquisition to the environmental conditions 210-1, 210-2. As mentioned above, the particular type of the environmental condition 210-1, 210-2 is not limited. Likewise, the amount of adaptation of the frame rate is not limited. In a simple scenario, it is possible to change video acquisition between two frame rates (cf. FIG. 4); in further scenarios, it is possible to change video acquisition between more than two frame rates. With reference to FIG. 4, in such a scenario, there may be provisioned a number of ranges of the environmental condition, wherein each range is mapped to a particular frame rate 311, 312. In other words, multiple thresholds may be provided 400. The frame rate 311, 312 may also depend on the type of the sensor 120-1, 120-2, 120-3 that indicates the change in the environmental condition.

In various implementations, the environmental condition 210-1, 210-2 can relate to a position of the device 180 in a reference frame. Alternatively or additionally, the environmental condition 210-1, 210-2 can relate to an orientation of the device in a reference frame. E.g., the reference frame can be defined globally or locally. E.g., if the reference frame is globally defined, the environmental condition can specify the position in terms of global latitude or longitude of the geographic coordinate system; likewise it is possible that the environmental condition 210-1, 210-2 specifies the orientation in terms of an angle against North direction and/or in terms of an angle against the horizontal. When the reference frame is locally defined, it is possible that the environmental condition specifies a distance to an object in a proximity of the device 100.

For the purpose of measuring the position and/or the orientation of the device 100, it is possible to employ a global positioning system (GPS) configured to measure a global position of the device, and/or a gyrometer configured to measure an angular acceleration of the device 100; and/or an accelerometer configured to measure an acceleration of the device 100; and/or a level configured to measure an angle against horizontal orientation; and/or a magnetic sensor configured to measure a global orientation of the device. A proximity sensor may be employed for detecting the position and/or orientation in a local reference frame; such a proximity sensor may operate by detecting a change in capacitance or may operate optically.

In general, the environmental condition 210-1, 210-2 cannot only be defined in terms of absolute values, but alternatively or additionally as well in terms of a time derivative, i.e., a delta of a measured value per time interval. Applying this rationale to the techniques above, it is possible that the environmental condition 210-1, 210-2 specifies a change in position per time interval, i.e., a speed of the device; it is also possible that the environmental condition 210-1, 210-2 specifies a change of speed of the device per time interval, i.e., an acceleration of the device.

There are further types of environmental conditions 210-1, 210-2 conceivable. E.g., the environmental condition 210-1, 210-2 can relate to at least one of the following: time, temperature, brightness, and pressure. Respective sensors can be provided.

It is also possible that the environmental condition 210-1, 210-2 relates to a physiological state of a user of the device. E.g., the physiological state can be at least one of the following: a pulse, a skin temperature, a body temperature, a blood sugar level, a sweat level, a heart rate, and a level of physical exertion. Respective data can be provided by a medical sensor. The medical sensor may be place in contact with the user.

In general, it is also possible to analyze the video 300 itself in order to determine the environmental condition. E.g., pixel values of the image data of the frames 301-1, 301-2 of the video 300 could be used in order to determine a brightness of the environment. A change of the pixel values of the image data of the frames 301-1, 301-2 could be user in order to determine a dynamic of the environment. In general, the environmental condition 210-1, 210-2 can relate to an optical view of the environment. This optical view may be recorded by the video and analyzed in order to quantify the environmental condition 210-1, 210-2. For this purpose, the processor 110-2 of the device 100 can be configured to analyze the acquired video to determine the optical view as the environmental condition. The processor 110-2 can be configured to send the control information to the interface 110-3.

As can be seen from the above, there exist various possibilities and scenarios for the environmental condition 210-1, 210-2. Various types of environmental conditions 210-1, 210-2 are conceivable. In general, it is possible to rely on a single environmental condition 210-1, 210-2 or a plurality of environmental condition 210-1, 210-2 when adapting the frame rate. It is possible to perform techniques of sensor fusion in order to combine information on various environmental conditions 210-1, 210-2 in order to control the frame rate 311, 312 of the acquisition of the video 300.

While above techniques are predominantly discussed where there are two levels of frame rates 311, 312 for the video acquisition, in general, there can be more than two frame rates 311, 312. Which particular frame rate 311, 312 is activated may depend on the various environmental conditions 210-1, 210-2 that are evaluated. Values of the frame rates 311, 312 can be retrieved from the database 110-4. For each type of environmental condition 210-1, 210-2, the database 110-4 can include an entry. Such an entry can link the first frame rate 311 with a first range of values of the respective environmental condition 210-1, 210-2 and further link the second frame rate 312 with a second range of values of the respective environmental condition 210-1, 210-2. In other words, if the current environment condition 210-1, 210-2 is situated within a specific range of values, the correspondingly linked frame rate 311, 312 can be activated. For this decision process, the threshold comparison may be employed.

The entries of the database 110-4 may be predefined and/or user defined. In particular, the user interface 110-5 can be configured to enable modification of these entries. Thereby, it is possible that the user controls the frame rates 311, 312 and the decision criterions for activation thereof. E.g., it is possible to have a respective graphical user interface with respective menu items. It is possible that the user can control which one of the sensors 120-1, 120-2, 120-3 or other inputs is used to trigger video acquisition at the first or second frame rate 311, 312. The frame rates 311, 312 can be set according to the user input. If, e.g., the user intends to save energy, it is possible that the first and second frame rates 311, 312 are set to lower values. If the user intends to acquire high quality video, the first and second frame rates 311, 312 may be set to higher values. If the user intends to, both, save energy and acquire high quality video where necessary, it is possible that the first frame rate 311 is set to a comparably high value while the second frame rate 312 is set to a comparably low value; at the same time, the decision criterion for adapting the frame rate 311, 312 in dependence of the environmental condition 210-1, 210-2 may be set to a comparably large or small sensitivity. As can be seen, both, the frame rates 311, 312, as well as the decision criterion for adapting the frame rates 311, 312 may be set by the user.

In FIG. 5, a method according to various embodiments is illustrated. The method starts with step S1. In step S2, the acquisition of the video 300 is started at a predefined frame rate 311, 312, e.g., the first frame rate 311. Next, in step S3, the interface 110-3 receives the control information 200 which indicates the current environmental condition 210-1, 210-2.

In step S4, it is checked whether there is a significant change in the current environmental condition 210-1, 210-2 as received in step S3. E.g., in step S4 it can be checked whether the current environmental condition 210-1, 210-2 exceeds the predefine threshold 400.

In general, in step S4, various decision criterions can be employed. E.g., if the speed of the device 100 exceeds a certain predefined threshold 400, a change may be detected in step S4—corresponding to a fulfilled decision criterion. Likewise, if an angular acceleration of the device 100 exceeds the predefined threshold 400, a fulfilled decision criterion can be detected in step S4. Likewise, if the time exceeds a certain predefined threshold 400—e.g., absolutely defined or defined with respected to the beginning of the video acquisition in step S2—a fulfilled decision criterion can be detected in step S4; by such techniques, it is possible to employ timers for changing the frame rate 311, 312 of the acquisition of the video 300. Similar decision criterions may be applied to different types of environmental conditions 210-1, 210-2 as mentioned above. E.g., when a significant variation acceleration of the device 100 is measured, a higher frame rate 311, 312 may be activated. Such a situation may occur when a user of the device 100 is skiing and goes quickly from side to side. Faster variations or higher accelerations can indicate the need for higher frame rates 311, 312—in particular if compared to a situation where a user of the device 100 is standing still, e.g., in the above-mentioned scenario of the skiing trip after the user finishes the downhill run and stands still at the bottom of the slope. Likewise, when a non-standard acceleration is measured, e.g., when a user of the device 100 is skydiving and jumps out of the plane, a high frame rate 311, 312 may be activated. When a gyrometer is employed as a sensor 120-1, 120-2, 120-3, recording speeds can be increased when the device 100 is repeatedly changing in direction. When a GPS is employed as a sensor 120-1, 120-2, 120-3, the frame rate 311, 312 can be increased based on changes in direction or quick movements between various locations. When a magnetic sensor is employed as a sensor 120-1, 120-2, 120-3, a high frame rate 311, 312 may be activated when the device 100 is rotating rapidly within the reference frame of earth magnetic field.

When a sensor 120-1, 120-2, 120-3 in form of a pulse monitor is employed, a high frame rate 311, 312 can be activated when the heart rate increases. E.g., based on the stress level of the user monitored by a medical sensor, a higher or lower frame rate 311, 312 can be activated. Similar considerations apply to a skin temperature sensor, a blood sugar level sensor, and a sweat level sensor. The sweat level sensor can, e.g., comprise a humidity sensor, a conductivity sensor for measuring the salt content, or other types of sensor to measure sweat. An electrical heart rate monitor such as an EKG can be applied as well.

When employing a proximity sensor, it is possible to activate a high frame rate based on the proximity of objects and/or users with respect to the device 100.

When employing a pressure sensor, it is possible to monitor the wind speed. E.g., when the wind speed increases, it is possible to activate a high speed recording rate. Likewise, a pressure sensor could be located in wearable electronics such as user's shoes. Based on the rate of walking or running of the user of the device 100, it is possible to activate a higher frame rate 311, 312. Such a decision criterion can be based on a speed of the steps and/or a pressure of the steps. A pressure sensor may be as well placed on a wrist band or arm band and measure whether the user is physically exerting, e.g., by lifting a heavy object. Such measurements can also be employed for activating a higher frame rate 311, 312. It is also possible to employ temperature sensors. E.g., a temperature sensor may be employed to measure an ambient temperature of the device 100. When the temperature drops, such as it is usually the case during night time, it is possible to activate a low frame rate 311, 312 for the video acquisition. A temperature sensor may also be employed in order to monitor a skin temperature of the user of the device 100. In such a manner, the temperature of the skin of the user of the device 100 and/or a difference between the skin temperature and the ambient temperature can be used as a decision criterion in step S4. Another environmental condition that can be used as a decision criterion in step S4, is the time of the day. It is possible to increase or decrease the frame rate 311, 312 based on the time of the day.

As mentioned above, it is possible that environmental conditions 210-1, 210-2 of the various sensors 120-1, 120-2, 120-3 as mentioned above are used independently or in combination (sensor fusion). E.g., in one scenario a proximity sensor can be used to increase the frame rate 311, 312 of the camera 110-1 used for long lapse photography—while the frame rate 311, 312 is also dependent on the time of the day. In a further scenario, it would be possible to increase or decrease the frame rate 311, 312 in dependence of the environmental condition 210-1, 210-2 corresponding to a heart rate of the user—but only during certain time of the day. E.g., during night time the heart rate could be neglected as a decision criterion in step S4. In other words, various decision criterions may be taking into account cumulatively in step S4, i.e., using AND and/or OR logical combinations; the various decision criterions may address different types of environmental conditions 210-1, 210-2.

As can be seen from the above, various combinations of environmental conditions 210-1, 210-2 and various combinations of decision criterions in step S4 are conceivable. Only when a respective change in the current environmental condition 210-1, 210-2 is determined in step S4, the frame rate 311, 312 of the video acquisition is changed in step S5. E.g., the change of the frame rate 311, 312 in step S5 may occur abruptly, i.e., implemented as a step function. Further, it is also possible that a progressive or gradual transition between the first and second frame rates is implemented. E.g., instead of abruptly changing the video acquisition from the first frame rate 311 to the second frame rate 312, it is possible to implement a gradual change between these values, e.g., over a transition time period of 2-5 seconds. E.g., when acquiring the video in fast or slow motion and a change in the environmental condition is detected such as a human audio input, it might be desirable to change the frame rate 311, 312 quickly, but progressively to a standard frame rate not corresponding to slow motion or fast motion. Additionally or alternatively, after a slow-motion jump, it might be desirable to return to normal film speed progressively rather than implementing an abrupt transition of frame rates. Otherwise, the video acquisition commences with the initial frame rate of step S2.

Steps S3, S4, and S5 are repeated until the end of video acquisition is reached (step S6). In latter case, the video acquisition is stopped in step S7 and ends in step S8.

It is to be understood that the concepts and techniques as explained above are subject to various modification. E.g., different types of sensors may yield different types of environmental conditions. While above various types of environmental conditions have been discussed in terms of absolute values, it is also possible that respective types of environmental conditions are defined in terms of a time derivative. Different decision criterions for switching between high and low frame rates may be employed, e.g., in combination with each other.

E.g., while above reference has been primarily made to first and second frame rates, a larger number of frame rates may be employed, e.g., in dependence of the current environmental condition. E.g., 4 or 8 or 20 or even more frame rates may be employed for video acquisition. E.g., there may be a mapping between values of the current environmental condition and an associated frame rate; the mapping may be binary or there may be a higher resolution mapping where for various ranges of environmental conditions different frame rates are assigned. Further, it may be possible that different sensors trigger a change to different frame rates.

E.g., for various sensors, a different number of frame rates may be assigned; the camera may be configured to acquire the video with at least one of the assigned number of frame rates in response to a change in the current environmental condition indicated by control information received from the respective sensor.

What is claimed is:

1. A device, comprising:
a camera configured to acquire a video at a first frame rate,
an interface configured to receive control information, the control information indicating a current environmental condition of an environment of the device,
wherein the camera is configured to acquire the video at a second frame rate in response to a change of the current environmental condition.

2. The device of claim 1,
wherein the environmental condition relates to at least one of a position or an orientation of the device in a reference frame.

3. The device of claim 2,
wherein the reference frame is globally defined or defined with respect to an object in the proximity of the device.

4. The device of claim 1,
wherein the environmental condition relates to a physiological state of a user of the device.

5. The device of claim 4,
wherein the physiological state relates to at least one of the following:
a pulse;
a skin temperature;
a body temperature;
a blood sugar level;
a sweat level;
a heart rate; and
a level of physical exertion.

6. The device of claim 1,
wherein the environmental condition relates to at least one of the following:
time;
temperature;
brightness; and
pressure.

7. The device of claim 1,
wherein the environmental condition relates to an optical view of the environment.

8. The device of claim 7,
wherein the device further comprises a processor,
wherein the processor is configured to analyze the acquired video to determine the optical view as the environmental condition,
wherein the processor is configured to send the control information to the interface.

9. The device of claim 1,
wherein the control information indicates at least one of an absolute value of the environmental condition or a time derivative of the environmental condition.

10. The device of claim 1,
wherein device further comprises a processor,
wherein the processor is configured to execute a threshold comparison of the current environmental condition with a predefined threshold,
wherein the processor is configured to command the camera to acquire the video at the second frame rate in dependence of the threshold comparison.

11. The device of claim 10,
wherein the processor is configured to command the camera to acquire the video at the second frame rate if an absolute value of the environmental condition falls below the predefined threshold, the second frame rate relating to acquisition of fewer frames per time interval than the first frame rate.

12. The device of claim 10,
wherein the processor is configured to retrieve the first frame rate and the second frame rate from a database, the database including an entry for each type of environmental condition,
wherein each entry links the first frame rate with a first range of values of the respective environmental condition and further links the second frame rate with a second range of values of the respective environmental condition.

13. The device of claim 12,
wherein the device further comprises a user interface configured to enable modification of the entries of the database by a user of the device.

14. The device of claim 10,
wherein the processor is configured to command the camera to gradually change the frame rate from the first frame rate to the second frame rate over a predefined transition time period.

15. A system, comprising:
at least one sensor configured to measure a current environmental condition of an environment of the sensor and to send control information indicating the current environmental condition,
a camera configured to acquire a video at a first frame rate,
an interface in communication with the at least one sensor and configured to receive the control information,
wherein the camera is configured to acquire the video at a second frame rate in response to a change of the current environmental condition.

16. The system of claim 15,
wherein the at least one sensor and the interface are wirelessly coupled.

17. The system of claim 15,
wherein the at least one sensor is one of the following:
an accelerometer configured to measure an acceleration of the device;
a gyrometer configured to measure angular acceleration of the device;
a Global Positioning System configured to measure a global position of the device;
a level configured to measure an angle against horizontal orientation;
a magnetic sensor configured to measure a global orientation of the device;
a clock configured to measure time;
a temperature sensor configured to measure a temperature;
a light sensitive element configured to measure a brightness;
a pressure sensor configured to measure a pressure;
a moisture sensor configured to measure moisture;
a proximity sensor configured to measure the distance to an object; and
a biomedical sensor configured to measure a physiological state of a user.

18. A method, comprising:
acquiring a video at a first frame rate,
while acquiring the video: receiving control information, the control information indicating a current environmental condition of an environment of the device,
selectively acquiring the video at a second frame rate in response to a change of the current environmental condition.

19. The method of claim 18, further comprising:
executing a threshold comparison of the current environmental condition with a predefined threshold,
commanding to acquire the video at the second frame rate in dependence of the threshold comparison.
